(19) United States
(12) Patent Application Publication
(10) Pub. No.: US 2025/0000138 A1
(43) Pub. Date: Jan. 2, 2025

(54) AEROSOL GENERATING DEVICE AND SYSTEM

(71) Applicant: KT&G CORPORATION, Daejeon (KR)

(72) Inventor: Wonkyeong LEE, Guri-si (KR)

(73) Assignee: KT&G CORPORATION, Daejeon (KR)

(21) Appl. No.: 18/276,499

(22) PCT Filed: Apr. 27, 2023
(86) PCT No.: PCT/KR2023/005829

§ 371 Date: Aug. 9, 2023

(30) Foreign Application Priority Data
May 2, 2022 (KR) 10-2022-0054376

(51) Int. Cl. A24F 40/20; A24D 1/20; A24F 40/10; A24F 40/46; A24F 40/465; H05B 6/10

(52) U.S. Cl. CPC A24F 40/20; A24D 1/20; A24F 40/10; A24F 40/46; A24F 40/465; H05B 6/108

(57) ABSTRACT

An aerosol generating system includes an aerosol generating article including an amorphous solid material and an aerosol generating device including a cavity configured to receive the aerosol generating article, a receptor configured to receive a liquid material from the aerosol generating article, and a heating structure configured to heat the amorphous solid material in a first temperature range in which the amorphous solid material undergoes a phase change into a liquid material and heat the liquid material in a second temperature range in which the liquid material undergoes a phase change into an aerosol, the second temperature range being different from the first temperature range.

### TECHNICAL FIELD

The disclosure relates to an aerosol generating device and system.

### BACKGROUND ART

Techniques for introducing airflow into an aerosol generating article are being developed to provide atomization performance. For example, aerosol generating devices that generate an aerosol from an aerosol generating article in a non-burning manner are being developed. The above description is information the inventor(s) acquired during the course of conceiving the disclosure, or already possessed at the time, and is not necessarily art publicly known before the present application was filed.

### DISCLOSURE OF THE INVENTION

### Technical Goals

An aspect of the disclosure may provide an aerosol generating device and system that reduces leakage of a material in a liquid state.

### Technical Solutions

An aerosol generating system may include an aerosol generating article including an amorphous solid material and an aerosol generating device including a cavity configured to receive the aerosol generating article, a receptor configured to receive a liquid material from the aerosol generating article, and a heating structure configured to heat the amorphous solid material in a first temperature range in which the amorphous solid material undergoes a phase change into a liquid material and heat the liquid material in a second temperature range in which the liquid material undergoes a phase change into an aerosol, the second temperature range being different from the first temperature range.

The heating structure may include a first surface plasmon resonance (SPR) heating structure configured to generate heat by SPR.

The heating structure may further include a second SPR heating structure disposed opposite to the first SPR heating structure with respect to the cavity and configured to generate heat by SPR, the first SPR heating structure may be configured to heat the aerosol generating article in the first temperature range, and the second SPR heating structure may be configured to heat the aerosol generating article in the second temperature range.

The first SPR heating structure may be configured to start heating at a first time, and the second SPR heating structure may be configured to start heating at a second time different from the first time.

The receptor may be disposed between the cavity and the second SPR heating structure.

When the aerosol generating article is inserted into the cavity, the first SPR heating structure may be configured to contact the aerosol generating article.

The aerosol generating device may further include a first light source configured to emit light toward the first SPR heating structure and a second light source configured to emit light toward the second SPR heating structure.

The heating structure may include an electrically conductive coil enclosing the cavity, and the aerosol generating article may include a susceptor configured to be coupled to the electrically conductive coil.

The heating structure may be configured to start heating at a first time and heat the aerosol generating article in the first temperature range and configured to start heating at a second time different from the first time and heat the aerosol generating article in the second temperature range.

The receptor may be disposed between the electrically conductive coil and the cavity.

The heating structure may include a first electrically resistive heating structure.

The heating structure may further include a second electrically resistive heating structure disposed opposite to the first electrically resistive heating structure with respect to the cavity, the first electrically resistive heating structure may be configured to heat the aerosol generating article in the first temperature range, and the second electrically resistive heating structure may be configured to heat the aerosol generating article in the second temperature range.

The first electrically resistive heating structure may be configured to start heating at a first time, and the second electrically resistive heating structure may be configured to start heating at a second time different from the first time.

The receptor may be disposed between the cavity and the second electrically resistive heating structure.

When the aerosol generating article is inserted into the cavity, the first electrically resistive heating structure may be configured to contact the aerosol generating article.

### Effects

According to an embodiment, leakage of a material in a liquid state from an aerosol generating device may be reduced. The effects of the aerosol generating device and system according to an embodiment are not limited to the above-mentioned effects, and other unmentioned effects may be clearly understood from the following description by one of ordinary skill in the art.

### BRIEF DESCRIPTION OF DRAWINGS

The foregoing and other aspects, features, and advantages of embodiments in the disclosure will become apparent from the following detailed description with reference to the accompanying drawings.

FIGS. 1 to 3 are diagrams illustrating examples of an aerosol generating article inserted into an aerosol generating device according to an embodiment.

FIGS. 4 and 5 are diagrams illustrating examples of an aerosol generating article according to an embodiment.

FIG. 6 is a block diagram of an aerosol generating device according to an embodiment.

FIG. 7 is a perspective view of an aerosol generating article according to an embodiment.

FIG. 8 is a plan view of an aerosol generating article according to an embodiment.

FIG. 9 is a side view of an aerosol generating article according to an embodiment.

FIG. 10 is a side view of an aerosol generating article viewed in another direction according to an embodiment.

FIG. 11 is a view schematically illustrating an aerosol generating system according to an embodiment.

FIG. 12 is a view illustrating an aerosol generating article inserted into an aerosol generating device according to an embodiment.

FIG. 13 is a view schematically illustrating an aerosol generating system according to an embodiment.

FIG. 14 is a view schematically illustrating an aerosol generating system according to an embodiment.

### MODE FOR CARRYING OUT THE INVENTION

The terms used to describe the embodiments are selected from among common terms that are currently widely used, in consideration of their function in the disclosure. However, different terms may be used depending on an intention of one of ordinary skill in the art, a precedent, or the advent of new technology. Also, in particular cases, the terms are arbitrarily selected by the applicant of the disclosure, and the meaning of those terms will be described in detail in the corresponding part of the detailed description. Therefore, the terms used to describe the disclosure should be defined based on the meanings of the terms and all the content of the disclosure, rather than the terms themselves.

It will be understood that when a certain part “includes” a certain component, the part does not exclude another component but may further include another component, unless the context clearly dictates otherwise. Also, terms such as “unit,” “module,” etc., as used in the specification may refer to a part for processing at least one function or operation and may be implemented as hardware, software, or a combination of hardware and software.

Hereinbelow, embodiments of the disclosure will be described in detail with reference to the accompanying drawings so that the embodiments may be readily implemented by one of ordinary skill in the technical field to which the disclosure pertains. However, the disclosure may be implemented in many different forms and is not limited to the embodiments described herein.

Hereinafter, embodiments of the disclosure will be described in detail with reference to the drawings.

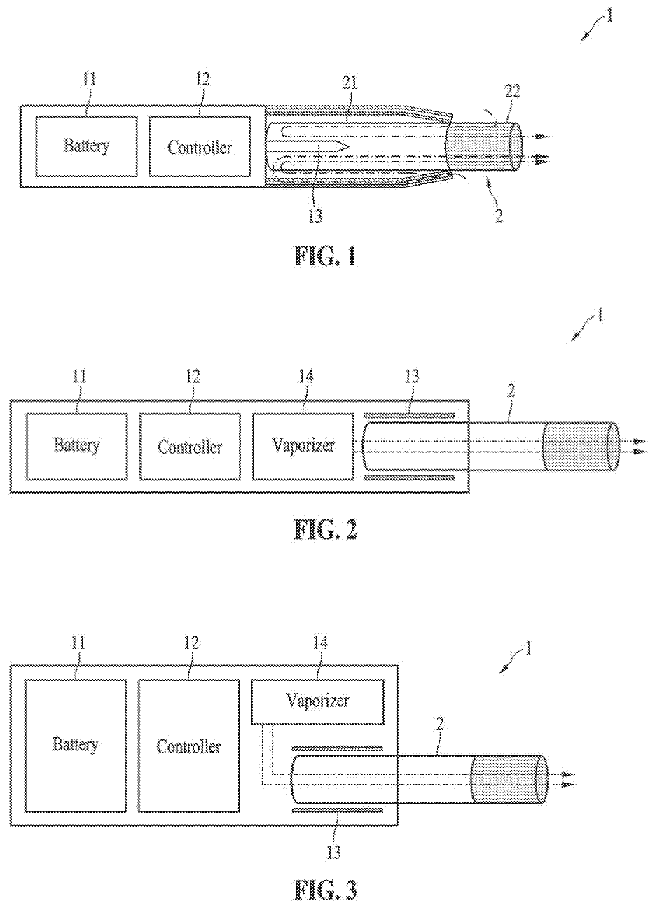

FIGS. 1 to 3 are diagrams illustrating examples of an aerosol generating article inserted into an aerosol generating device.

Referring to FIG. 1, an aerosol generating device 1 may include a battery 11, a controller 12, and a heater 13. Referring to FIGS. 2 and 3, the aerosol generating device 1 may further include a vaporizer 14. In addition, an aerosol generating article 2 (e.g., a cigarette) may be inserted into an inner space of the aerosol generating device 1.

The aerosol generating device 1 shown in FIGS. 1 to 3 may include components related to the embodiments described herein. Therefore, it is to be understood by one of ordinary skill in the art to which the disclosure pertains that the aerosol generating device 1 may further include other general-purpose components in addition to the ones shown in FIGS. 1 to 3.

In addition, although it is shown that the heater 13 is included in the aerosol generating device 1 in FIGS. 2 and 3, the heater 13 may be omitted as needed.

FIG. 1 illustrates a linear alignment of the battery 11, the controller 12, and the heater 13. FIG. 2 illustrates a linear alignment of the battery 11, the controller 12, the vaporizer 14, and the heater 13. FIG. 3 illustrates a parallel alignment of the vaporizer 14 and the heater 13. However, an internal structure of the aerosol generating device 1 is not limited to what is shown in FIGS. 1 to 3. That is, the alignments of the battery 11, the controller 12, the heater 13, and the vaporizer 14 may be changed depending on the design of the aerosol generating device 1.

When the aerosol generating article 2 is inserted into the aerosol generating device 1, the aerosol generating device 1 may operate the heater 13 and/or the vaporizer 14 to generate an aerosol. The aerosol generated by the heater 13 and/or the vaporizer 14 may pass through the aerosol generating article 2 into a user.

Even when the aerosol generating article 2 is not inserted into the aerosol generating device 1, the aerosol generating device 1 may heat the heater 13 as needed.

The battery 11 may supply power to be used to operate the aerosol generating device 1. For example, the battery 11 may supply power to heat the heater 13 or the vaporizer 14, and may supply power required for the controller 12 to operate. In addition, the battery 11 may supply power required to operate a display, a sensor, a motor, or the like installed in the aerosol generating device 1.

The controller 12 may control the overall operation of the aerosol generating device 1. Specifically, the controller 12 may control respective operations of other components included in the aerosol generating device 1, in addition to the battery 11, the heater 13, and the vaporizer 14. In addition, the controller 12 may verify a state of each of the components of the aerosol generating device 1 to determine whether the aerosol generating device 1 is in an operable state.

The controller 12 may include at least one processor. The processor may be implemented as an array of a plurality of logic gates, or may be implemented as a combination of a general-purpose microprocessor and a memory in which a program executable in the microprocessor is stored. In addition, it is to be understood by one of ordinary skill in the art to which the disclosure pertains that the processor may be implemented in other types of hardware.

The heater 13 may be heated by the power supplied by the battery 11. For example, when an aerosol generating article is inserted into the aerosol generating device 1, the heater 13 may be disposed outside the aerosol generating article. The heated heater 13 may thus raise the temperature of an aerosol generating material in the aerosol generating article.

The heater 13 may be an electrically resistive heater. For example, the heater 13 may include an electrically conductive track, and the heater 13 may be heated as a current flows through the electrically conductive track. However, the heater 13 is not limited to the foregoing example, and any example of heating the heater 13 up to a desired temperature may be applicable without limitation. Here, the desired temperature may be preset in the aerosol generating device 1 or may be set by the user.

As another example, the heater 13 may be an induction heater. Specifically, the heater 13 may include an electrically conductive coil for heating the aerosol generating article in an induction heating manner, and the aerosol generating article may include a susceptor to be heated by the induction heater.

For example, the heater 13 may include a tubular heating element, a plate-shaped heating element, a needle-shaped heating element, or a rod-shaped heating element, and may heat the inside or outside of the aerosol generating article 2 according to the shape of a heating element.

In addition, the heater 13 may be provided as a plurality of heaters in the aerosol generating device 1. In this case, the plurality of heaters 13 may be disposed to be inserted into the aerosol generating article 2 or may be disposed outside the aerosol generating article 2. In addition, some of the plurality of heaters 13 may be disposed to be inserted into the aerosol generating article 2, and the rest may be disposed outside the aerosol generating article 2. However, the shape of the heater 13 is not limited to what is shown in FIGS. 1 to 3 but may be provided in various shapes.

The vaporizer 14 may heat a liquid composition to generate an aerosol, and the generated aerosol may pass through the aerosol generating article 2 into the user. That is, the aerosol generated by the vaporizer 14 may travel along an airflow path of the aerosol generating device 1, and the airflow path may be configured such that the aerosol generated by the vaporizer 14 may pass through the aerosol generating article into the user.

For example, the vaporizer 14 may include a liquid storage (e.g., a reservoir), a liquid transfer means, and a heating element. However, embodiments are not limited thereto. For example, the liquid storage, the liquid transfer means, and the heating element may be included as independent modules in the aerosol generating device 1.

The liquid storage may store the liquid composition. For example, the liquid composition may be a liquid including a tobacco-containing material having a volatile tobacco flavor ingredient, or a liquid including a non-tobacco material. The liquid storage may be manufactured to be detachable and attachable from and to the vaporizer 14, or may be manufactured in an integral form with the vaporizer 14.

The liquid composition may include, for example, water, a solvent, ethanol, a plant extract, a fragrance, a flavoring agent, or a vitamin mixture. The fragrance may include, for example, menthol, peppermint, spearmint oil, various fruit-flavored ingredients, and the like. However, embodiments are not limited thereto. The flavoring agent may include ingredients that provide the user with a variety of flavors or scents. The vitamin mixture may be a mixture of at least one of vitamin A, vitamin B, vitamin C, or vitamin E, but is not limited thereto. The liquid composition may also include an aerosol former such as glycerin and propylene glycol.

The liquid transfer means may transfer the liquid composition in the liquid storage to the heating element. The liquid transfer means may be, for example, a wick such as cotton fiber, ceramic fiber, glass fiber, or porous ceramic. However, embodiments are not limited thereto.

The heating element may be an element configured to heat the liquid composition transferred by the liquid transfer means. The heating element may be, for example, a metal heating wire, a metal heating plate, a ceramic heater, or the like. However, embodiments are not limited thereto. In addition, the heating element may include a conductive filament such as a nichrome wire, and may be arranged in a structure wound around the liquid transfer means. The heating element may be heated as a current is supplied and may transfer heat to the liquid composition in contact with the heating element, and may thereby heat the liquid composition. As a result, an aerosol may be generated.

For example, the vaporizer 14 may also be referred to as a cartomizer or an atomizer. However, embodiments are not limited thereto.

The aerosol generating device 1 may further include general-purpose components in addition to the battery 11, the controller 12, the heater 13, and the vaporizer 14. For example, the aerosol generating device 1 may include a display that outputs visual information and/or a motor that outputs tactile information. In addition, the aerosol generating device 1 may include at least one sensor (e.g., a puff sensor, a temperature sensor, an aerosol generating article insertion detection sensor, etc.). In addition, the aerosol generating device 1 may be manufactured to have a structure allowing external air to be introduced or internal gas to flow out even while the aerosol generating article 2 is inserted.

Although not shown in FIGS. 1 to 3, the aerosol generating device 1 may constitute a system along with a separate cradle. For example, the cradle may be used to charge the battery 11 of the aerosol generating device 1. Alternatively, the cradle may be used to heat the heater 13, with the cradle and the aerosol generating device 1 coupled.

The aerosol generating article 2 may be similar to a conventional combustible cigarette. For example, the aerosol generating article 2 may be divided into a first portion including an aerosol generating material and a second portion including a filter or the like. Alternatively, the second portion of the aerosol generating article 2 may also include the aerosol generating material. For example, the aerosol generating material provided in the form of granules or capsules may be inserted into the second portion.

The first portion may be entirely inserted into the aerosol generating device 1, and the second portion may be exposed outside. Alternatively, only the first portion may be partially inserted into the aerosol generating device 1, or the first portion may be entirely inserted into the aerosol generating device 1 and the second portion may be partially inserted into the aerosol generating device 1. The user may inhale the aerosol with the second portion in a mouth of the user. In this case, the aerosol may be generated as external air passes through the first portion, and the generated aerosol may pass through the second portion into the mouth of the user.

For example, the external air may be introduced through at least one air path formed in the aerosol generating device 1. In this example, opening or closing and/or the size of the air path formed in the aerosol generating device 1 may be adjusted by the user. Accordingly, an amount of atomization, a sense of smoking, or the like may be adjusted by the user. As another example, the external air may be introduced into the inside of the aerosol generating article 2 through at least one hole formed on a surface of the aerosol generating article 2.

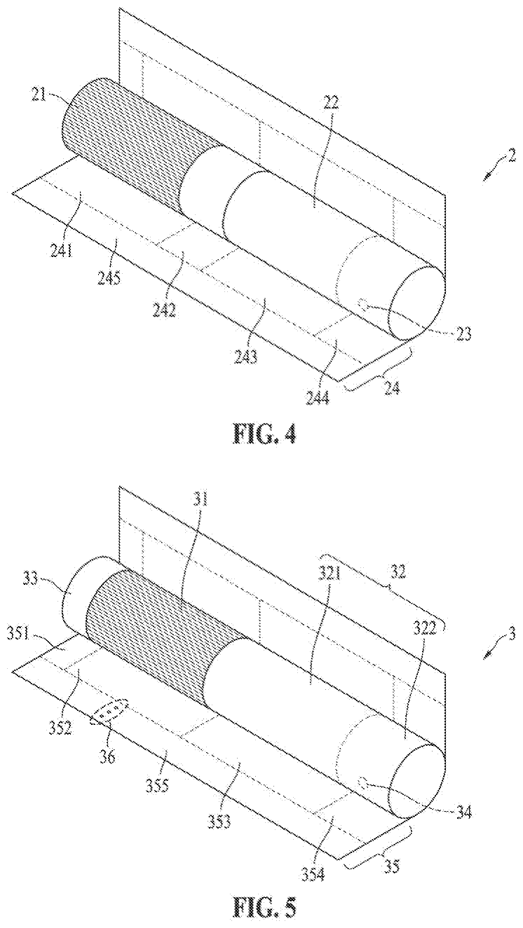

Hereinafter, examples of the aerosol generating article 2 will be described with reference to FIGS. 4 and 5.

FIGS. 4 and 5 are diagrams illustrating examples of an aerosol generating article.

Referring to FIG. 4, the aerosol generating article 2 may include a tobacco rod 21 and a filter rod 22. The first portion and the second portion described above with reference to FIGS. 1 to 3 may include the tobacco rod 21 and the filter rod 22, respectively.

Although the filter rod 22 is illustrated as having a single segment in FIG. 4, embodiments are not limited thereto. That is, the filter rod 22 may include a plurality of segments. For example, the filter rod 22 may include a segment that cools an aerosol and a segment that filters a predetermined ingredient contained in an aerosol. In addition, the filter rod 22 may further include at least one segment that performs another function, as needed.

A diameter of the aerosol generating article 2 may be in a range of 5 millimeters (mm) to 9 mm, and a length thereof may be about 48 mm. However, embodiments are not limited thereto. For example, a length of the tobacco rod 21 may be about 12 mm, a length of a first segment of the filter rod 22 may be about 10 mm, a length of a second segment of the filter rod 22 may be about 14 mm, and a length of a third segment of the filter rod 22 may be about 12 mm. However, embodiments are not limited thereto.

The aerosol generating article 2 may be wrapped with at least one wrapper 24. The wrapper 24 may have at least one hole through which external air is introduced or internal gas is discharged. As an example, the aerosol generating article 2 may be wrapped with one wrapper 24. As another example, the aerosol generating article 2 may be wrapped with two or more of wrappers 24 in an overlapping manner. For example, the tobacco rod 21 may be wrapped with a first wrapper 241, and the filter rod 22 may be wrapped with wrappers 242, 243, and 244. In addition, the aerosol generating article 2 may be entirely wrapped again with a single wrapper 245. For example, when the filter rod 22 includes a plurality of segments, the plurality of segments may be wrapped with the wrappers 242, 243, and 244, respectively.

The first wrapper 241 and the second wrapper 242 may be formed of general filter wrapping paper. For example, the first wrapper 241 and the second wrapper 242 may be porous wrapping paper or non-porous wrapping paper. In addition, the first wrapper 241 and the second wrapper 242 may be formed of oilproof paper and/or an aluminum laminated wrapping material. The third wrapper 243 may be formed of hard wrapping paper. For example, a basis weight of the third wrapper 243 may be in a range of 88 grams per square meter (g/m²) to 96 g/m², and desirably, may be in a range of 90 g/m² to 94 g/m². In addition, a thickness of the third wrapper 243 may be in a range of 120 micrometers (μm) to 130 μm, and desirably, may be 125 μm.

The fourth wrapper 244 may be formed of oilproof hard wrapping paper. For example, a basis weight of the fourth wrapper 244 may be in a range of 88 g/m² to 96 g/m², and desirably, may be in a range of 90 g/m² to 94 g/m². In addition, a thickness of the fourth wrapper 244 may be in a range of 120 μm to 130 μm, and desirably, may be 125 μm.

The fifth wrapper 245 may be formed of sterile paper (e.g., MFW). Here, the sterile paper (MFW) may refer to paper specially prepared such that it has enhanced tensile strength, water resistance, smoothness, or the like, compared to general paper. For example, a basis weight of the fifth wrapper 245 may be in a range of 57 g/m² to 63 g/m², and desirably, may be 60 g/m². In addition, a thickness of the fifth wrapper 245 may be in a range of 64 μm to 70 μm, and desirably, may be 67 μm.

The fifth wrapper 245 may have a predetermined material internally added thereto. The material may be, for example, silicon. However, embodiments are not limited thereto. Silicon may have properties, such as, for example, heat resistance which is characterized by less change by temperature, oxidation resistance which refers to resistance to oxidation, resistance to various chemicals, water repellency against water, or electrical insulation. However, silicon may not be necessarily used, but any material having such properties described above may be applied to (or used to coat) the fifth wrapper 245 without limitation.

The fifth wrapper 245 may prevent the aerosol generating article 2 from burning. For example, there may be a probability that the aerosol generating article 2 burns when the tobacco rod 21 is heated by the heater 13. Specifically, when the temperature rises above the ignition point of any one of the materials included in the tobacco rod 21, the aerosol generating article 2 may burn. Even in this case, it may still be possible to prevent the aerosol generating article 2 from burning because the fifth wrapper 245 includes a non-combustible material.

In addition, the fifth wrapper 245 may prevent an aerosol generating device (e.g., holder) from being contaminated by materials produced in the aerosol generating article 2. Liquid materials may be produced in the aerosol generating article 2 when a user puffs. For example, as an aerosol generated in the aerosol generating article 2 is cooled by external air, such liquid materials (e.g., moisture, etc.) may be produced. As the aerosol generating article 2 is wrapped with the fifth wrapper 245, the liquid materials generated within the aerosol generating article 2 may be prevented from leaking out of the aerosol generating article 2.

The tobacco rod 21 may include an aerosol generating material. The aerosol generating material may include, for example, at least one of glycerin, propylene glycol, ethylene glycol, dipropylene glycol, diethylene glycol, triethylene glycol, tetraethylene glycol, or oleyl alcohol. However, embodiments are not limited thereto. The tobacco rod 21 may also include other additives such as, for example, a flavoring agent, a wetting agent, and/or an organic acid. In addition, the tobacco rod 21 may include a flavoring liquid such as menthol or a moisturizing agent that is added as being sprayed onto the tobacco rod 21.

The tobacco rod 21 may be manufactured in various forms. For example, the tobacco rod 21 may be formed as a sheet or a strand. Alternatively, the tobacco rod 21 may be formed of tobacco leaves finely cut from a tobacco sheet. In addition, the tobacco rod 21 may be enveloped by a thermally conductive material. The thermally conductive material may be, for example, metal foil such as aluminum foil. However, embodiments are not limited thereto. For example, the thermally conductive material enveloping the tobacco rod 21 may evenly distribute the heat transferred to the tobacco rod 21 to improve the conductivity of the heat to be applied to the tobacco rod 21, thereby improving the taste of tobacco. In addition, the thermally conductive material enveloping the tobacco rod 21 may function as a susceptor heated by an induction heater. In this case, although not shown, the tobacco rod 21 may further include an additional susceptor in addition to the thermally conductive material enveloping the outside thereof.

The filter rod 22 may be a cellulose acetate filter. However, a shape of the filter rod 22 is not limited. For example, the filter rod 22 may be a cylindrical rod, or a tubular rod including a hollow therein. The filter rod 22 may also be a recess-type rod. For example, when the filter rod 22 includes a plurality of segments, at least one of the segments may be manufactured in a different shape.

A first segment of the filter rod 22 may be a cellulose acetate filter. For example, the first segment may be a tubular structure including a hollow therein. The first segment may prevent internal materials of the tobacco rod 21 from being pushed back when the heater 13 is inserted into the tobacco rod 21 and may cool the aerosol. A desirable diameter of the hollow included in the first segment may be adopted from a range of 2 mm to 4.5 mm. However, embodiments are not limited thereto.

A desirable length of the first segment may be adopted from a range of 4 mm to 30 mm. However, embodiments are not limited thereto. Desirably, the length of the first segment may be 10 mm. However, embodiments are not limited thereto.

The first segment may have a hardness that is adjustable through an adjustment of the content of a plasticizer in the process of manufacturing the first segment. In addition, the first segment may be manufactured by inserting a structure such as a film or a tube of the same or different materials therein (e.g., in the hollow).

A second segment of the filter rod 22 may cool an aerosol generated as the heater 13 heats the tobacco rod 21. The user may thus inhale the aerosol cooled down to a suitable temperature.

The length or diameter of the second segment may be determined in various ways according to the shape of the aerosol generating article 2. For example, a desirable length of the second segment may be adopted from a range of 7 mm to 20 mm. Desirably, the length of the second segment may be about 14 mm. However, embodiments are not limited thereto.

The second segment may be manufactured by weaving a polymer fiber. In this case, a flavoring liquid may be applied to a fiber formed of a polymer. Alternatively, the second segment may be manufactured by weaving a separate fiber to which a flavoring liquid is applied and the fiber formed of the polymer together. Alternatively, the second segment may be formed with a crimped polymer sheet.

For example, the polymer may be prepared with a material selected from a group consisting of polyethylene (PE), polypropylene (PP), polyvinyl chloride (PVC), polyethylene terephthalate (PET), polylactic acid (PLA), cellulose acetate (CA), and aluminum foil.

As the second segment is formed with the woven polymer fiber or the crimped polymer sheet, the second segment may include a single channel or a plurality of channels extending in a longitudinal direction. A channel used herein may refer to a path through which gas (e.g., air or aerosol) passes.

For example, the second segment formed with the crimped polymer sheet may be formed of a material having a thickness between about 5 μm and about 300 μm, for example, between about 10 μm and about 250 μm. In addition, a total surface area of the second segment may be between about 300 square millimeters per millimeter (mm²/mm) and about 1000 mm²/mm. Further, an aerosol cooling element may be formed from a material having a specific surface area between about 10 square millimeters per milligram (mm²/mg) and about 100 mm²/mg.

The second segment may include a thread containing a volatile flavor ingredient. The volatile flavor ingredient may be menthol. However, embodiments are not limited thereto. For example, the thread may be filled with an amount of menthol sufficient to provide at least 1.5 mg of menthol to the second segment.

A third segment of the filter rod 22 may be a cellulose acetate filter. A desirable length of the third segment may be adopted from a range of 4 mm to 20 mm. For example, the length of the third segment may be about 12 mm. However, embodiments are not limited thereto.

The third segment may be manufactured such that a flavor is generated by spraying a flavoring liquid onto the third segment in the process of manufacturing the third segment. Alternatively, a separate fiber to which the flavoring liquid is applied may be inserted into the third segment. An aerosol generated in the tobacco rod 21 may be cooled as it passes through the second segment of the filter rod 22, and the cooled aerosol may pass through the third segment into the user. Accordingly, when a flavoring element is added to the third segment, the flavor carried to the user may last much longer.

In addition, the filter rod 22 may include at least one capsule 23. Here, the capsule 23 may perform a function of generating a flavor or a function of generating an aerosol. For example, the capsule 23 may have a structure in which a liquid containing a fragrance is wrapped with a film. The capsule 23 may have a spherical or cylindrical shape. However, embodiments are not limited thereto.

Referring to FIG. 5, an aerosol generating article 3 may further include a front end plug 33. The front end plug 33 may be disposed on one side of a tobacco rod 31 opposite to a filter rod 32. The front end plug 33 may prevent the tobacco rod 31 from escaping to the outside, and may also prevent an aerosol liquefied in the tobacco rod 31 during smoking from flowing into an aerosol generating device (e.g., the aerosol generating device 1 of FIGS. 1 to 3).

The filter rod 32 may include a first segment 321 and a second segment 322. Here, the first segment 321 may correspond to the first segment of the filter rod 22 of FIG. 4, and the second segment 322 may correspond to the third segment of the filter rod 22 of FIG. 4.

A diameter and a total length of the aerosol generating article 3 may correspond to the diameter and the total length of the aerosol generating article 2 of FIG. 4. For example, a length of the front end plug 33 may be about 7 mm, a length of the tobacco rod 31 may be about 15 mm, a length of the first segment 321 may be about 12 mm, and a length of the second segment 322 may be about 14 mm. However, embodiments are not limited thereto.

The aerosol generating article 3 may be wrapped by at least one wrapper 35. The wrapper 35 may have at least one hole through which external air is introduced or internal gas is discharged. For example, the front end plug 33 may be wrapped with a first wrapper 351, the tobacco rod 31 may be wrapped with a second wrapper 352, the first segment 321 may be wrapped with a third wrapper 353, and the second segment 322 may be wrapped with a fourth wrapper 354. In addition, the aerosol generating article 3 may be entirely wrapped again with a fifth wrapper 355.

In addition, at least one perforation 36 may be formed in the fifth wrapper 355. For example, the perforation 36 may be formed in a region enclosing the tobacco rod 31. However, embodiments are not limited thereto. The perforation 36 may perform a function of transferring heat generated by the heater 13 shown in FIGS. 2 and 3 to the inside of the tobacco rod 31.

In addition, the second segment 322 may include at least one capsule 34. Here, the capsule 34 may perform a function of generating a flavor or a function of generating an aerosol. For example, the capsule 34 may have a structure in which a liquid containing a fragrance is wrapped with a film. The capsule 34 may have a spherical or cylindrical shape. However, embodiments are not limited thereto.

The first wrapper 351 may be a combination of general filter wrapping paper and metal foil such as aluminum foil. For example, a total thickness of the first wrapper 351 may be in a range of 45 μm to 55 μm, and desirably, may be 50.3 μm. Further, a thickness of the metal foil of the first wrapper 351 may be in a range of 6 μm to 7 μm, and desirably, may be 6.3 μm. In addition, a basis weight of the first wrapper 351 may be in a range of 50 g/m² to 55 g/m², and desirably, may be 53 g/m².

The second wrapper 352 and the third wrapper 353 may be formed with general filter wrapping paper. For example, the second wrapper 352 and the third wrapper 353 may be porous wrapping paper or non-porous wrapping paper.

For example, the porosity of the second wrapper 352 may be 35000 CU. However, embodiments are not limited thereto. Further, a thickness of the second wrapper 352 may be in a range of 70 μm to 80 μm, and desirably, may be 78 μm. In addition, a basis weight of the second wrapper 352 may be in a range of 20 g/m² to 25 g/m², and desirably, may be 23.5 g/m².

For example, the porosity of the third wrapper 353 may be 24000 CU. However, embodiments are not limited thereto. Further, a thickness of the third wrapper 353 may be in a range of 60 μm to 70 μm, and desirably, may be 68 μm. In addition, a basis weight of the third wrapper 353 may be in a range of 20 g/m² to 25 g/m², and desirably, may be 21 g/m².

The fourth wrapper 354 may be formed with polylactic acid (PLA) laminated paper. Here, the PLA laminated paper may refer to three-ply paper including a paper layer, a PLA layer, and another paper layer. For example, a thickness of the fourth wrapper 354 may be in a range of 100 μm to 120 μm, and desirably, may be 110 μm. In addition, a basis weight of the fourth wrapper 354 may be in a range of 80 g/m² to 100 g/m², and desirably, may be 88 g/m².

The fifth wrapper 355 may be formed of sterile paper (e.g., MFW). Here, the sterile paper (MFW) may refer to paper specially prepared such that it has enhanced tensile strength, water resistance, smoothness, or the like, compared to general paper. For example, a basis weight of the fifth wrapper 355 may be in a range of 57 g/m² to 63 g/m², and desirably, may be 60 g/m². Further, a thickness of the fifth wrapper 355 may be in a range of 64 μm to 70 μm, and desirably, may be 67 μm.

The fifth wrapper 355 may have a predetermined material internally added thereto. The material may be, for example, silicon. However, embodiments are not limited thereto. Silicon may have properties, such as, for example, heat resistance which is characterized by less change by temperature, oxidation resistance which refers to resistance to oxidation, resistance to various chemicals, water repellency against water, or electrical insulation. However, silicon may not be necessarily used, but any material having such properties described above may be applied to (or used to coat) the fifth wrapper 355 without limitation.

The front end plug 33 may be formed of cellulose acetate. For example, the front end plug 33 may be manufactured by adding a plasticizer (e.g., triacetin) to cellulose acetate tow. A mono denier of a filament of the cellulose acetate tow may be in a range of 1.0 to 10.0, and desirably, may be in a range of 4.0 to 6.0. The mono denier of the filament of the front end plug 33 may be more desirably 5.0. In addition, a cross section of the filament of the front end plug 33 may be Y-shaped. A total denier of the front end plug 33 may be in a range of 20000 to 30000, and desirably, may be in a range of 25000 to 30000. The total denier of the front end plug 33 may be more desirably 28000.

In addition, as needed, the front end plug 33 may include at least one channel, and a cross-sectional shape of the channel may be provided in various ways.

The tobacco rod 31 may correspond to the tobacco rod 21 described above with reference to FIG. 4. Thus, a detailed description of the tobacco rod 31 will be omitted here.

The first segment 321 may be formed of cellulose acetate. For example, the first segment may be a tubular structure including a hollow therein. The first segment 321 may be manufactured by adding a plasticizer (e.g., triacetin) to cellulose acetate tow. For example, a mono denier and a total denier of the first segment 321 may be the same as the mono denier and the total denier of the front end plug 33.

The second segment 322 may be formed of cellulose acetate. A mono denier of a filament of the second segment 322 may be in a range of 1.0 to 10.0, and desirably, may be in a range of 8.0 to 10.0. The mono denier of the filament of the second segment 322 may be more desirably 9.0. In addition, a cross section of the filament of the second segment 322 may be Y-shaped. A total denier of the second segment 322 may be in a range of 20000 to 30000, and desirably, may be 25000.

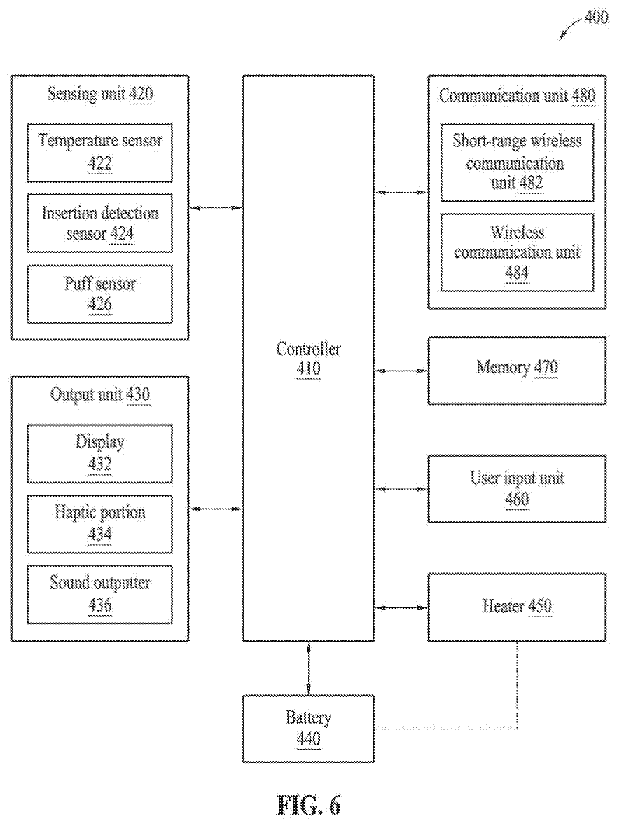

FIG. 6 is a block diagram of an aerosol generating device 400 according to an embodiment. The aerosol generating device 400 may include a controller 410, a sensing unit 420, an output unit 430, a battery 440, a heater 450, a user input unit 460, a memory 470, and a communication unit 480. However, an internal structure of the aerosol generating device 400 is not limited to what is shown in FIG. 6. It is to be understood by one of ordinary skill in the art to which the disclosure pertains that some of the components shown in FIG. 6 may be omitted or new components may be added according to the design of the aerosol generating device 400.

The sensing unit 420 may sense a state of the aerosol generating device 400 or a state of an environment around the aerosol generating device 400, and transmit sensing information obtained through the sensing to the controller 410. Based on the sensing information, the controller 410 may control the aerosol generating device 400 to control operations of the heater 450, restrict smoking, determine whether an aerosol generating article (e.g., a cigarette, a cartridge, etc.) is inserted, display a notification, and perform other functions.

The sensing unit 420 may include at least one of a temperature sensor 422, an insertion detection sensor 424, or a puff sensor 426. However, embodiments are not limited thereto.

The temperature sensor 422 may sense a temperature at which the heater 450 (or an aerosol generating material) is heated. The aerosol generating device 400 may include a separate temperature sensor for sensing the temperature of the heater 450, or the heater 450 itself may perform a function as a temperature sensor. Alternatively, the temperature sensor 422 may be arranged around the battery 440 to monitor the temperature of the battery 440.

The insertion detection sensor 424 may sense whether the aerosol generating article is inserted and/or removed. The insertion detection sensor 424 may include, for example, at least one of a film sensor, a pressure sensor, a light sensor, a resistive sensor, a capacitive sensor, an inductive sensor, or an infrared sensor, which may sense a signal change by the insertion and/or removal of the aerosol generating article.

The puff sensor 426 may sense a puff from a user based on various physical changes in an airflow path or airflow channel. For example, the puff sensor 426 may sense the puff from the user based on any one of a temperature change, a flow change, a voltage change, and a pressure change.

The sensing unit 420 may further include at least one of a temperature/humidity sensor, an atmospheric pressure sensor, a magnetic sensor, an acceleration sensor, a gyroscope sensor, a position sensor (e.g., a global positioning system (GPS)), a proximity sensor, or a red, green, blue (RGB) sensor (e.g., an illuminance sensor), in addition to the sensors 422 to 426 described above. A function of each sensor may be intuitively inferable from its name by one of ordinary skill in the art, and thus, a more detailed description thereof will be omitted here.

The output unit 430 may output information about the state of the aerosol generating device 400 and provide the information to the user. The output unit 430 may include at least one of a display 432, a haptic portion 434, or a sound outputter 436. However, embodiments are not limited thereto. When the display 432 and a touchpad are provided in a layered structure to form a touchscreen, the display 432 may be used as an input device in addition to an output device.

The display 432 may visually provide information about the aerosol generating device 400 to the user. The information about the aerosol generating device 400 may include, for example, a charging/discharging state of the battery 440 of the aerosol generating device 400, a preheating state of the heater 450, an insertion/removal state of the aerosol generating article, a limited usage state (e.g., an abnormal article detected) of the aerosol generating device 400, or the like, and the display 432 may externally output the information. The display 432 may be, for example, a liquid-crystal display panel (LCD), an organic light-emitting display panel (OLED), or the like. The display 432 may also be in the form of a light-emitting diode (LED) device.

The haptic portion 434 may provide information about the aerosol generating device 400 to the user in a haptic way by converting an electrical signal into a mechanical stimulus or an electrical stimulus. The haptic portion 434 may include, for example, a motor, a piezoelectric element, or an electrical stimulation device.

The sound outputter 436 may provide information about the aerosol generating device 400 to the user in an auditory way. For example, the sound outputter 436 may convert an electrical signal into a sound signal and externally output the sound signal.

The battery 440 may supply power to be used to operate the aerosol generating device 400. The battery 440 may supply power to heat the heater 450. In addition, the battery 440 may supply power required for operations of the other components (e.g., the sensing unit 420, the output unit 430, the user input unit 460, the memory 470, and the communication unit 480) included in the aerosol generating device 400. The battery 440 may be a rechargeable battery or a disposable battery. The battery 440 may be, for example, a lithium polymer (LiPoly) battery. However, embodiments are not limited thereto.

The heater 450 may receive power from the battery 440 to heat the aerosol generating material. Although not shown in FIG. 6, the aerosol generating device 400 may further include a power conversion circuit (e.g., a direct current (DC)-to-DC (DC/DC) converter) that converts power of the battery 440 and supplies the power to the heater 450. In addition, when the aerosol generating device 400 generates an aerosol in an induction heating manner, the aerosol generating device 400 may further include a DC-to-alternating current (AC) (DC/AC) converter that converts DC power of the battery 440 into AC power.

The controller 410, the sensing unit 420, the output unit 430, the user input unit 460, the memory 470, and the communication unit 480 may receive power from the battery 440 to perform functions. Although not shown in FIG. 6, the aerosol generating device 400 may further include a power conversion circuit, for example, a low dropout (LDO) circuit or a voltage regulator circuit, that converts the power of the battery 440 and supplies the power to respective components.

In an embodiment, the heater 450 may be formed of any suitable electrically resistive material. The electrically resistive material may be a metal or a metal alloy including, for example, titanium, zirconium, tantalum, platinum, nickel, cobalt, chromium, hafnium, niobium, molybdenum, tungsten, tin, gallium, manganese, iron, copper, stainless steel, nichrome, or the like. However, embodiments are not limited thereto. In addition, the heater 450 may be implemented as a metal heating wire, a metal heating plate on which an electrically conductive track is arranged, a ceramic heating structure, or the like, but is not limited thereto.

In an embodiment, the heater 450 may be an induction heater. For example, the heater 450 may include a susceptor that heats the aerosol generating material by generating heat through a magnetic field applied by a coil.

In an embodiment, the heater 450 may include a plurality of heaters. For example, the heater 450 may include a first heater for heating an aerosol generating article and a second heater for heating a liquid.

The user input unit 460 may receive information input from the user or may output information to the user. For example, the user input unit 460 may include a keypad, a dome switch, a touchpad (e.g., a contact capacitive type, a pressure resistive film type, an infrared sensing type, a surface ultrasonic conduction type, an integral tension measurement type, a piezo effect method, etc.), a jog wheel, a jog switch, or the like. However, embodiments are not limited thereto. In addition, although not shown in FIG. 6, the aerosol generating device 400 may further include a connection interface such as a universal serial bus (USB) interface, and may be connected to another external device through the connection interface such as a USB interface to transmit and receive information or to charge the battery 440.

The memory 470, which is hardware for storing various pieces of data processed in the aerosol generating device 400, may store data processed by the controller 410 and data to be processed by the controller 410. The memory 470 may include at least one type of storage medium of a flash memory type memory, a hard disk type memory, a multimedia card micro type memory, a card type memory (e.g., an SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, or an optical disk. The memory 470 may store an operating time of the aerosol generating device 400, a maximum number of puffs, a current number of puffs, at least one temperature profile, data associated with a smoking pattern of the user, or the like.

The communication unit 480 may include at least one component for communicating with another electronic device. For example, the communication unit 480 may include a short-range wireless communication unit 482 and a wireless communication unit 484.

The short-range wireless communication unit 482 may include a Bluetooth communication unit, a Bluetooth low energy (BLE) communication unit, a near field communication unit, a wireless local area network (WLAN) wireless fidelity (Wi-Fi) communication unit, a ZigBee communication unit, an infrared data association (IrDA) communication unit, a Wi-Fi direct (WFD) communication unit, an ultra-wideband (UWB) communication unit, and an Ant+ communication unit. However, embodiments are not limited thereto.

The wireless communication unit 484 may include, for example, a cellular network communication unit, an Internet communication unit, a computer network (e.g., a LAN or a wide-area network (WAN)) communication unit, or the like. However, embodiments are not limited thereto. The wireless communication unit 484 may use subscriber information (e.g., international mobile subscriber identity (IMSI)) to identify and authenticate the aerosol generating device 400 in a communication network.

The controller 410 may control the overall operation of the aerosol generating device 400. In an embodiment, the controller 410 may include at least one processor. The processor may be implemented as an array of a plurality of logic gates, or may be implemented as a combination of a general-purpose microprocessor and a memory in which a program executable in the microprocessor is stored. In addition, it is to be understood by one of ordinary skill in the art to which the disclosure pertains that it may be implemented in other types of hardware.

The controller 410 may control the temperature of the heater 450 by controlling the supply of power from the battery 440 to the heater 450. For example, the controller 410 may control the supply of power by controlling switching of a switching element between the battery 440 and the heater 450. As another example, a direct heating circuit may control the supply of power to the heater 450 according to a control command from the controller 410.

The controller 410 may analyze a sensing result obtained by the sensing of the sensing unit 420 and control processes to be performed thereafter. For example, the controller 410 may control power to be supplied to the heater 450 to start or end an operation of the heater 450 based on the sensing result obtained by the sensing unit 420. As another example, the controller 410 may control an amount of power to be supplied to the heater 450 and a time for which the power is to be supplied, such that the heater 450 may be heated up to a predetermined temperature or maintained at a desired temperature, based on the sensing result obtained by the sensing unit 420.

The controller 410 may control the output unit 430 based on the sensing result obtained by the sensing unit 420. For example, when a number of puffs counted through the puff sensor 426 reaches a preset number, the controller 410 may inform the user that the aerosol generating device 400 is ending soon, through at least one of the display 432, the haptic portion 434, or the sound outputter 436.

In an embodiment, the controller 410 may control a power supply time and/or a power supply amount for the heater 450 according to a state of the aerosol generating article sensed by the sensing unit 420. For example, when the aerosol generating article is in an over-humidified state, the controller 410 may control the power supply time for an inductive coil to increase a preheating time, compared to a case where the aerosol generating article is in a general state.

An embodiment may be implemented in the form of a recording medium including instructions executable by a computer, such as a program module executable by the computer. A computer-readable medium may be any available medium that may be accessed by a computer and includes a volatile medium, a non-volatile medium, a removable medium, and a non-removable medium. In addition, the computer-readable medium may include both a computer storage medium and a communication medium. The computer storage medium includes all of a volatile medium, a non-volatile medium, a removable medium, and a non-removable medium implemented by any method or technology for storage of information such as computer-readable instructions, data structures, program modules or other data. The communication medium typically includes computer-readable instructions, data structures, other data in modulated data signals such as program modules, or other transmission mechanisms, and includes any information transfer medium.

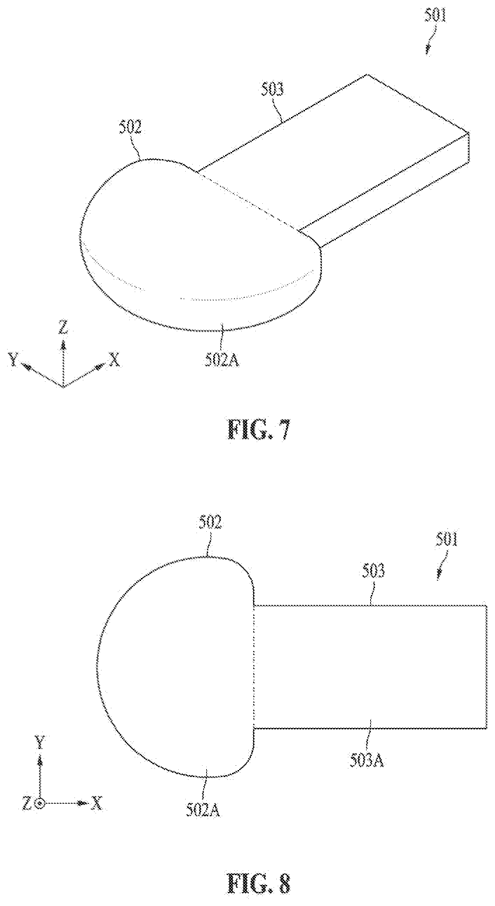

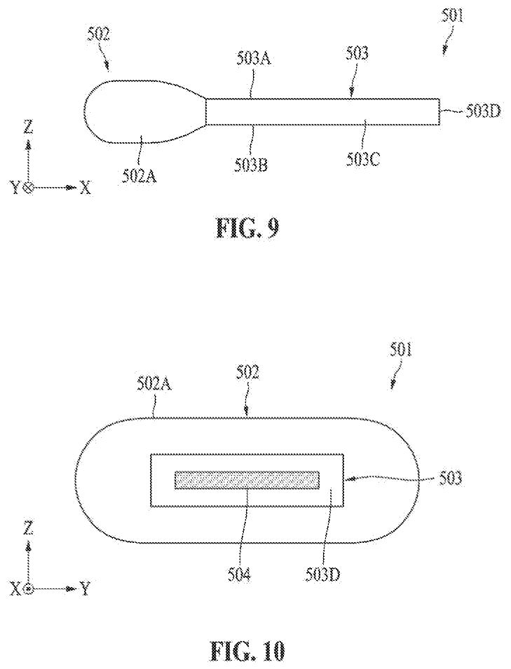

FIG. 7 is a perspective view of an aerosol generating article according to an embodiment, and FIG. 8 is a plan view of an aerosol generating article according to an embodiment. FIG. 9 is a side view of an aerosol generating article according to an embodiment, and FIG. 10 is a side view of an aerosol generating article viewed in another direction according to an embodiment.

Referring to FIGS. 7 to 10, an aerosol generating article 501 may include an amorphous solid material. The “amorphous solid material” may be referred to a “monolithic solid material” (i.e., non-fibrous material) or a “dried gel”. The amorphous solid is a solid material that may retain some fluid, such as liquid, within it. The amorphous solid may comprise at least a portion of an aerosol-generating material. The amorphous solid material may be in a solid phase in a first temperature range (e.g., less than about 70° C.), may be in a liquid phase in a second temperature range (e.g., greater than or equal to about 70° C. and less than about 150° C.) different from the first temperature range, and may be in a gas phase or an aerosol in a third temperature range (e.g., greater than or equal to about 150° C.) different from the second temperature range. The amorphous solid material may be configured to undergo a phase change from a solid phase into a liquid phase and from the liquid phase into a gas phase depending on a condition (e.g., temperature) of an environment in which the amorphous solid material is present.

The amorphous solid material may be formed of a gelling agent. In an embodiment, the amorphous solid material may include a flavoring agent, glycerol, and a tobacco material (e.g., nicotine). In an embodiment, the amorphous solid material may include glycerol and a tobacco material.

In an embodiment, the aerosol generating article 501 may include a first part 502 and a second part 503 extending from the first part 502 in one direction (e.g., a +X direction).

The first part 502 may have substantially a curved surface 502A. For example, the first part 502 may have substantially a hemispherical shape.

The second part 503 may include a first surface 503A (e.g., a front surface), a second surface 503B (e.g., a rear surface) opposite to the first surface 503A, a plurality of side surfaces 503C located between the first surface 503A and the second surface 503B, and an end surface 503D located between the first surface 503A and the second surface 503B and between the plurality of side surfaces 503C. In an embodiment, the first surface 503A, the second surface 503B, the plurality of side surfaces 503C, and/or the end surface 503D may be formed as substantially flat surfaces.

In an embodiment, the amorphous solid material may be included in the second part 503. In some embodiments, a portion of the amorphous solid material may also be included in the first part 502.

In an embodiment, the second part 503 may include a discharge portion 504 formed on the end surface 503D. The discharge portion 504 may be configured to discharge a liquid material when the amorphous solid material undergoes a phase change from a solid phase into a liquid phase. In some embodiments, the discharge portion 504 may be formed on at least one surface of the first surface 503A, the second surface 503B, and the plurality of side surfaces 503C.

The second part 503 may be thick enough to be inserted into an aerosol generating device. For example, a distance (e.g., a thickness of the second part 503) between the first surface 503A and the second surface 503B may be defined in a range of about 0.02 mm to about 0.3 mm.

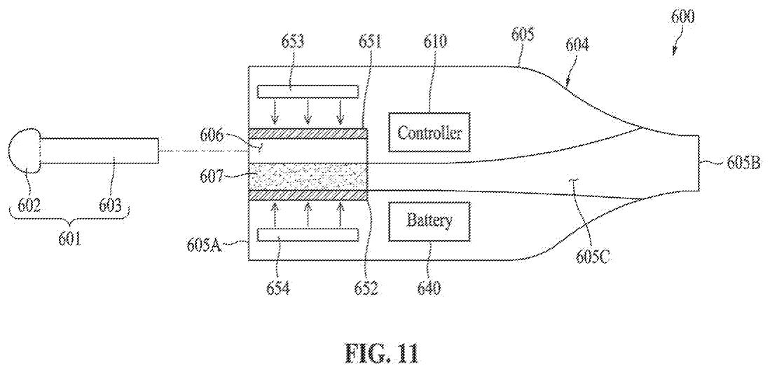

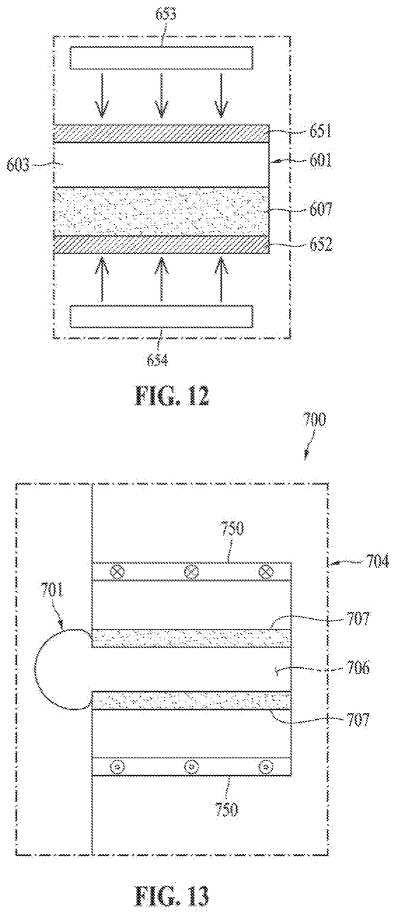

FIG. 11 is a view schematically illustrating an aerosol generating system according to an embodiment, and FIG. 12 is a view illustrating an aerosol generating article inserted into an aerosol generating device according to an embodiment.

Referring to FIGS. 11 and 12, an aerosol generating system 600 may include an aerosol generating article 601 (e.g., the aerosol generating article 501) and an aerosol generating device 604 configured to generate an aerosol from the aerosol generating article 601.

The aerosol generating article 601 may include an amorphous solid material. The aerosol generating article 601 may include a first part 602 and a second part 603 extending from the first part 602 and at least partially inserted into the aerosol generating device 604.

The aerosol generating device 604 may include a housing 605. The housing 605 may include a first end 605A, a second end 605B (e.g., a mouthpiece end), and an airflow channel 605C extending between the first end 605A and the second end 605B. In an embodiment, the housing 605 may include at least one air inlet formed on the first end 605A. In an embodiment, the air inlet may be formed on another portion (e.g., a side surface) of the housing 605.

The aerosol generating device 604 may include a cavity 606 formed in the housing 605. The cavity 606 may be in fluid communication with the airflow channel 605C. The cavity 606 may be separated from the airflow channel 605C. The cavity 606 may be sized to receive at least a portion (e.g., the second part 603) of the aerosol generating article 601. The cavity 606 may be connected to the first end 605A of the housing 605 and extend from the first end 605A toward the second end 605B.

The aerosol generating device 604 may include a receptor 607 configured to receive a liquid material. The receptor 607 may include an absorbent element. For example, the absorbent element may include a wick. The receptor 607 may be disposed at least partially in the airflow channel 605C and/or the cavity 606. The receptor 607 may absorb a liquid material discharged from the aerosol generating article 601.

In an embodiment, the aerosol generating device 604 may not include the receptor 607. When the aerosol generating article 601 is inserted into the cavity 606, the liquid material discharged from the aerosol generating article 601 may flow through the airflow channel 605C and may be sucked in by a user through the second end 605B.

The aerosol generating device 604 may include a heating structure 651, 652 configured to heat a target material (e.g., an amorphous solid material or a liquid material). The heating structure 651, 652 may heat the aerosol generating article 601 when the aerosol generating article 601 is inserted into the cavity 606.

In an embodiment, the heating structure 651, 652 may be configured to heat the aerosol generating article 601 using heat generated by surface plasmon resonance (SPR). “SPR” refers to collective oscillations of electrons propagating along an interface of metal particles with a medium. For example, the collective oscillations of electrons of metal particles may be caused by light propagating from the outside (e.g., a light source 653, 654) of the heating structure 651, 652. The excitation of the electrons of metal particles may generate thermal energy, and the generated thermal energy may be transferred within an environment to which the heating structure 651, 652 is applied. Using SPR may reduce power consumption of the heating structure 651, 652.

In an embodiment, the heating structure 651, 652 may include a substrate and a plurality of metal particles formed on the substrate. In an embodiment, the heating structure 651, 652 may include at least one metal prism formed on the substrate. In an embodiment, the heating structure 651, 652 may include a metal film formed on the substrate.

In an embodiment, the heating structure 651, 652 may include the first SPR heating structure 651 and the second SPR heating structure 652. The first SPR heating structure 651 may be disposed on a first side (e.g., an upper side in FIGS. 11 and 12) with respect to the cavity 606, and the second SPR heating structure 652 may be disposed on a second side (e.g., a lower side in FIGS. 11 and 12) opposite to the first side with respect to the cavity 606.

In an embodiment, the first SPR heating structure 651 and the second SPR structure 652 may be configured to heat the target material in different temperature ranges. For example, the first SPR heating structure 651 may heat an amorphous solid material in a temperature range (e.g., greater than or equal to about 70° C. and less than about 150° C.) that allows the amorphous solid material in the aerosol generating article 601 to undergo a phase change into a liquid material, and the second SPR heating structure 652 may be configured to heat the liquid material in a temperature range (e.g., greater than or equal to about 150° C.) that allows the liquid material to undergo a phase change into a gas material (e.g., an aerosol).

In an embodiment, the first SPR heating structure 651 and the second SPR heating structure 652 may start heating at different times. In some embodiments, the first SPR heating structure 651 may start heating before the second SPR heating structure 652 starts heating. For example, when the first SPR heating structure 651 heats the amorphous solid material in the aerosol generating article 601 and allows the amorphous solid material to undergo a phase change into the liquid material and the liquid material is discharged from the aerosol generating article 601 and received in the receptor 607, the second SPR heating structure 652 may heat the liquid material in the receptor 607 and allow the liquid material to undergo a phase change into an aerosol. An interval between a point in time at which the first SPR heating structure 651 starts heating and a point in time at which the second SPR heating structure 652 starts heating may be defined by a predetermined time or a time based on a user input. The interval may be determined by a sensor (not shown) that detects the liquid material in the receptor 607.

In an embodiment, the first SPR heating structure 651 and the second SPR heating structure 652 may have different structures. For example, the first SPR heating structure 651 may include a substrate having first thermal conductivity, and the second SPR heating structure 652 may include a substrate having second thermal conductivity different from the first thermal conductivity. As another example, the first SPR heating structure 651 may include a first metal (e.g., gold), and the second SPR heating structure 652 may include a second metal (e.g., silver). As yet another example, the first SPR heating structure 651 may include an integrated metal prism that defines an opening, and the second SPR heating structure 652 may include a plurality of metal prisms that defines an opening. Forming the first SPR heating structure 651 and the second SPR heating structure 652 in different structures may implement different temperature-increasing characteristics or different target temperatures.

In an embodiment, the first SPR heating structure 651 may be disposed to touch the cavity 606. When the aerosol generating article 601 is inserted into the cavity 606, the first SPR heating structure 651 may at least partially contact the second part 603. In an embodiment, the first SPR heating structure 651 may be disposed adjacent to or spaced apart from the cavity 606.

In an embodiment, the second SPR heating structure 652 may be spaced apart from the cavity 606. For example, the receptor 607 may be disposed between the cavity 606 and the second SPR heating structure 652. In an embodiment, the second SPR heating structure 652 may be disposed adjacent to the cavity 606 or disposed to touch the cavity 606.

In an embodiment, the heating structure 651, 652 may be implemented as a single heating structure. For example, the single heating structure may be implemented as the first SPR heating structure 651 or the second SPR heating structure 652. The single heating structure may heat an amorphous solid material in a temperature range that allows the amorphous solid material to undergo a phase change into a liquid material and then heat the liquid material in a temperature range that allows the liquid material to undergo a phase change into a gas material.

The aerosol generating device 604 may include the light source 653, 654 configured to emit light toward the heating structure 651, 652.

In an embodiment, the light source 653, 654 may be configured to transmit a light signal toward the heating structure 651, 652 at a determined angle. For example, the light source 653, 654 may transmit a light signal at an angle that may cause total reflection on a surface (e.g., a surface of a substrate and/or a surface of a metal prism) of the heating structure 651, 652. In an embodiment, the light source 653, 654 may transmit a light signal toward the heating structure 651, 652 at any angle.

In an embodiment, the light source 653, 654 may be configured to transmit light in an ultraviolet band, a visible band, and/or an infrared band. In some embodiments, the light source 653, 654 may be configured to transmit light in the visible band (e.g., about 380 nanometers (nm) to about 780 nm).

In some embodiments, the light source 653, 654 may be configured to transmit light in a band corresponding to metal particles that form the heating structure 651, 652. For example, the light source 653, 654 may transmit light in a wavelength band corresponding to an average maximum absorbance according to the metal particles. In an embodiment in which the heating structure 651, 652 is formed of gold, the light source 653, 654 may transmit light having a wavelength of about 638 nm.

In an embodiment, the light source 653, 654 may transmit light at any suitable output. For example, the light source 653, 654 may transmit light at an output of about 1,000 milliwatts (mW).

In an embodiment, the light source 653, 654 may include a light-emitting diode and/or a laser. The light-emitting diode and/or the laser may be of a type and/or size suitable for being included in the aerosol generating device 604. For example, the laser may include a solid-state laser and/or a semiconductor laser.

In an embodiment, the aerosol generating device 604 may include a first light source 653 configured to emit light toward the first SPR heating structure 651 and a second light source 654 configured to emit light toward the second SPR heating structure 652. In an embodiment, the aerosol generating device 604 may include a single heating structure and a single light source configured to emit light toward the single heating structure. In an embodiment, the aerosol generating device 604 may not include the light source 653, 654. The heating structure 651, 652 may use external light of the aerosol generating device 604.

In an embodiment, the first light source 653 and the second light source 654 may be implemented as the same type of light source. In an embodiment, the first light source 653 and the second light source 654 may be implemented as different types of light source.

In an embodiment, at least one light source 653, 654 of the first light source 653 and the second light source 654 may be configured to locally irradiate the heating structure 651, 652.

In an embodiment, the first light source 653 and the second light source 654 may be configured to irradiate substantially at the same time. In an embodiment, an irradiation point in time of any one light source of the first light source 653 and the second light source 654 may be different from an irradiation point in time of another light source.

In an embodiment, the first light source 653 and the second light source 654 may irradiate the heating structure 651, 652 for substantially the same time. In an embodiment, an irradiation time of any one light source of the first light source 653 and the second light source 654 may be different from an irradiation time of another light source.

In an embodiment, the first light source 653 and the second light source 654 may transmit light of substantially the same wavelength band. In an embodiment, a band of light radiated by any one light source of the first light source 653 and the second light source 654 may be different from a band of light radiated by another light source.

In an embodiment, the first light source 653 and the second light source 654 may irradiate the heating structure 651, 652 with substantially the same illuminance. In an embodiment, an illuminance of any one light source of the first light source 653 and the second light source 654 may be different from an illuminance of another light source.

In an embodiment, the aerosol generating device 604 may include a controller 610 and a battery 640. In an embodiment, the aerosol generating device 604 may not include the battery 640.

An operating method of the aerosol generating system 600 according to an embodiment is described. The aerosol generating article 601 may be inserted into the cavity 606 of the aerosol generating device 604. The first light source 653 may emit light toward the first SPR heating structure 651. The aerosol generating article 601 touching the first SPR heating structure 651 may be heated, and the amorphous solid material in the aerosol generating article 601 may first undergo a phase change into a liquid material. The liquid material may be slightly discharged from the aerosol generating article 601 and flow into the receptor 607. The second light source 654 may emit light toward the second SPR heating structure 652. The second SPR heating structure 652 may heat the liquid material received in the receptor 607. The liquid material may secondarily undergo a phase change into an aerosol. The aerosol may pass through the second end 605B into the user along the airflow channel 605C.

FIG. 13 is a view schematically illustrating an aerosol generating system according to an embodiment.

Referring to FIG. 13, an aerosol generating system 700 may include an aerosol generating article 701 and an aerosol generating device 704. The aerosol generating article 701 may include an amorphous solid material. In an embodiment, the aerosol generating article 701 may include an electrically conductive material, an electromagnetic material, or a magnetic material. For example, the aerosol generating article 701 may include a susceptor. The aerosol generating device 704 may include a cavity 706, a receptor 707, and a heating structure 750.

In an embodiment, the receptor 707 may be disposed to at least partially enclose the cavity 706. In an embodiment, the receptor 707 may include a plurality of receiving portions disposed around a circumference of the cavity 706. In an embodiment, the receptor 707 may include a first receiving portion disposed on a first side (e.g., an upper side) of the cavity 706 and a second receiving portion disposed on a second side (e.g., a lower side) opposite to the first side of the cavity 706.

In an embodiment, the receptor 707 may include an absorbent element. For example, the absorbent element may include a wick. The receptor 707 may absorb a liquid material discharged from the aerosol generating article 701.

In an embodiment, the heating structure 750 may include an electrically conductive coil. The electrically conductive coil may be configured to be magnetically or electrically coupled to the aerosol generating article 701. The electrically conductive coil may be wound clockwise around the circumference of the cavity 706. The electrically conductive coil may be wound counterclockwise around the circumference of the cavity 706.

In an embodiment, the heating structure 750 may be implemented as a single heating structure.

In an embodiment, the heating structure 750 may be disposed to enclose the receptor 707. The heating structure 750 and the receptor 707 may be spaced apart from each other with a gap formed therebetween. The heating structure 750 and the receptor 707 may substantially contact each other.

In an embodiment, the heating structure 750 may be configured to heat the aerosol generating article 701 in a temperature range (e.g., greater than or equal to about 70° C. and less than about 150° C.) in which the amorphous solid material in the aerosol generating article 701 undergoes a phase change into a liquid material. The liquid material resulting from the phase change may flow into the receptor 707. The heating structure 750 may be configured to heat the liquid material in a temperature range (e.g., greater than or equal to about 150° C.) in which the liquid material undergoes a phase change into a gas material (e.g., an aerosol).

In an embodiment, the heating structure 750 may start heating at different times to change a phase. For example, the heating structure 750 may heat the amorphous solid material at a first time and allow the amorphous solid material to undergo a phase change into the liquid material and heat the liquid material at a second time (e.g., a second time later than the first time) different from the first time and allow the liquid material to undergo a phase change into the gas material. An interval between the first time and the second time may be defined by a predetermined time or a time based on a user input. The interval may be determined by a sensor (not shown) that detects the liquid material in the receptor 707.

In an embodiment, the aerosol generating device 704 may not include the receptor 707. The liquid material, obtained by heating the amorphous solid material in the aerosol generating article 701 and allowing the amorphous solid material to undergo the phase change, may flow out of the aerosol generating device 704 without being aerosolized.

An operating method of the aerosol generating system 700 according to an embodiment is described. The aerosol generating article 701 may be inserted into the cavity 706 in the aerosol generating device 704. Electrical energy may be applied to the heating structure 750, and the aerosol generating article 701 may be heated by magnetic or electromagnetic coupling between the heating structure 750 and the aerosol generating article 701. The amorphous solid material in the aerosol generating article 701 may undergo the phase change into the liquid material. The liquid material may be discharged from the aerosol generating article 701 and may flow into the receptor 707. More electrical energy may be applied to the heating structure 750, and the liquid material in the receptor 707 may undergo the phase change into the aerosol by greater coupling. The aerosol may flow out of the aerosol generating device 704.

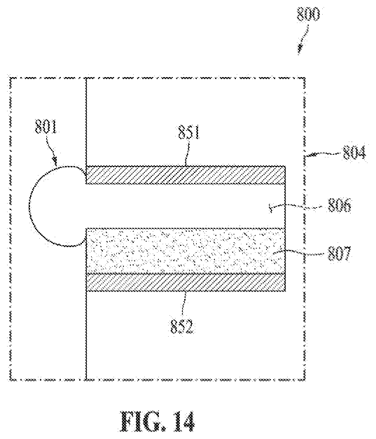

FIG. 14 is a view schematically illustrating an aerosol generating system according to an embodiment.

Referring to FIG. 14, an aerosol generating system 800 may include an aerosol generating article 801 and an aerosol generating device 804. The aerosol generating article 801 may include an amorphous solid material. The aerosol generating device 804 may include a cavity 806, a receptor 807, and a heating structure 851, 852.

In an embodiment, the receptor 807 may be disposed on one side (e.g., a lower side) of the cavity 806. In an embodiment, the receptor 807 may be disposed to at least partially enclose a circumference of the cavity 806.

In an embodiment, the receptor 807 may include an absorbent element. For example, the absorbent element may include a wick. The receptor 807 may absorb a liquid material discharged from the aerosol generating article 801.

In an embodiment, the heating structure 851, 852 may include an electrically resistive heating structure.

In an embodiment, the heating structure 851, 852 may include a first electrically resistive heating structure 851 and a second electrically resistive heating structure 852. The first electrically resistive heating structure 851 may be disposed on a first side (e.g., an upper side) with respect to the cavity 806, and the second electrically resistive heating structure 852 may be disposed on a second side (e.g., a lower side) opposite to the first side with respect to the cavity 806.

In an embodiment, the first electrically resistive heating structure 851 and the second electrically resistive heating structure 852 may be configured to heat a target material in different temperature ranges. For example, the first electrically resistive heating structure 851 may heat the amorphous solid material in the aerosol generating article 801 in a temperature range (e.g., greater than or equal to about 70° C. and less than about 150° C.) that allows the amorphous solid material to undergo a phase change into a liquid material, and the second electrically resistive heating structure 852 may be configured to heat the liquid material in a temperature range (e.g., greater than or equal to about 150° C.) that allows the liquid material to undergo a phase change into a gas material (e.g., an aerosol).

In an embodiment, the first electrically resistive heating structure 851 and the second electrically resistive heating structure 852 may start heating at different times. In some embodiments, the first electrically resistive heating structure 851 may start heating before the second electrically resistive heating structure 852 starts heating. For example, when the first electrically resistive heating structure 851 heats the amorphous solid material in the aerosol generating article 801 and allows the amorphous solid material to undergo a phase change into the liquid material and the liquid material is discharged from the aerosol generating article 801 and received in the receptor 807, the second electrically resistive heating structure 852 may heat the liquid material in the receptor 807 and allow the liquid material to undergo a phase change into an aerosol. An interval between a point in time at which the first electrically resistive heating structure 851 starts heating and a point in time at which the second electrically resistive heating structure 852 starts heating may be defined by a predetermined time or a time based on a user input. The interval may be determined by a sensor (not shown) that detects the liquid material in the receptor 807.

In an embodiment, the first electrically resistive heating structure 851 may be disposed to touch the cavity 806. When the aerosol generating article 801 is inserted into the cavity 806, the first electrically resistive heating structure 851 may at least partially contact the aerosol generating article 801. In an embodiment, the first electrically resistive heating structure 851 may be disposed adjacent to or spaced apart from the cavity 806.

In an embodiment, the second electrically resistive heating structure 852 may be spaced apart from the cavity 806. For example, the receptor 807 may be disposed between the cavity 806 and the second electrically resistive heating structure 852. In an embodiment, the second electrically resistive heating structure 852 may be disposed adjacent to the cavity 806 or disposed to touch the cavity 806.

In an embodiment, the heating structure 851, 852 may be implemented as a single heating structure. For example, the single heating structure may be implemented as the first electrically resistive heating structure 851 or the second electrically resistive heating structure 852. The single heating structure may heat an amorphous solid material in a temperature range that allows the amorphous solid material to undergo a phase change into a liquid material and then heat the liquid material in a temperature range that allows the liquid material to undergo a phase change into a gas material.

In an embodiment, the aerosol generating device 804 may not include the receptor 807. The liquid material obtained by heating the amorphous solid material in the aerosol generating article 801 and allowing the amorphous solid material to undergo the phase change may flow out of the aerosol generating device 804 without being aerosolized.

An operating method of the aerosol generating system 800 according to an embodiment is described. The aerosol generating article 801 may be inserted into the cavity 806 in the aerosol generating device 804. The aerosol generating article 801 touching the first electrically resistive heating structure 851 may be heated, and the amorphous solid material in the aerosol generating article 801 may first undergo a phase change into a liquid material. The liquid material may be slightly discharged from the aerosol generating article 801 and flow into the receptor 807. The second electrically resistive heating structure 852 may heat the liquid material received in the receptor 807. The liquid material may secondarily undergo a phase change into an aerosol. The aerosol may flow out of the aerosol generating device 804.

The embodiments of the disclosure are intended to be illustrative and not restrictive. Various modifications may be made to the detailed description of the disclosure including the accompanying scope of claims and equivalents. Any of the embodiment(s) described herein may be used in combination with any other embodiment(s) described herein.

1. An aerosol generating system comprising:
an aerosol generating article comprising an amorphous solid material; and
an aerosol generating device comprising a cavity configured to receive the aerosol generating article, a receptor configured to receive a liquid material from the aerosol generating article, and a heating structure configured to heat the amorphous solid material in a first temperature range in which the amorphous solid material undergoes a phase change into the liquid material and heat the liquid material in a second temperature range in which the liquid material undergoes a phase change into an aerosol, the second temperature range being different from the first temperature range.

2. The aerosol generating system of claim 1, wherein the heating structure comprises a first surface plasmon resonance (SPR) heating structure configured to generate heat by SPR.

3. The aerosol generating system of claim 2, wherein
the heating structure further comprises a second SPR heating structure disposed opposite to the first SPR heating structure with respect to the cavity and configured to generate heat by SPR, and
the first SPR heating structure is configured to heat the aerosol generating article in the first temperature range, and the second SPR heating structure is configured to heat the aerosol generating article in the second temperature range.

4. The aerosol generating system of claim 3, wherein the first SPR heating structure is configured to start heating at a first time, and the second SPR heating structure is configured to start heating at a second time different from the first time.

5. The aerosol generating system of claim 3, wherein the receptor is disposed between the cavity and the second SPR heating structure.

6. The aerosol generating system of claim 2, wherein, when the aerosol generating article is inserted into the cavity, the first SPR heating structure is configured to contact the aerosol generating article.

7. The aerosol generating system of claim 3, wherein the aerosol generating device further comprises:
a first light source configured to emit light toward the first SPR heating structure; and
a second light source configured to emit light toward the second SPR heating structure.

8. The aerosol generating system of claim 1, wherein the heating structure comprises an electrically conductive coil enclosing the cavity, and the aerosol generating article comprises a susceptor configured to be coupled to the electrically conductive coil.

9. The aerosol generating system of claim 8, wherein the heating structure is configured to start heating at a first time and heat the aerosol generating article in the first temperature range and configured to start heating at a second time different from the first time and heat the aerosol generating article in the second temperature range.

10. The aerosol generating system of claim 8, wherein the receptor is disposed between the electrically conductive coil and the cavity.

11. The aerosol generating system of claim 1, wherein the heating structure comprises a first electrically resistive heating structure.

12. The aerosol generating system of claim 11, wherein
the heating structure further comprises a second electrically resistive heating structure disposed opposite to the first electrically resistive heating structure with respect to the cavity, and
the first electrically resistive heating structure is configured to heat the aerosol generating article in the first temperature range, and the second electrically resistive heating structure is configured to heat the aerosol generating article in the second temperature range.

13. The aerosol generating system of claim 12, wherein the first electrically resistive heating structure is configured to start heating at a first time, and the second electrically resistive heating structure is configured to start heating at a second time different from the first time.

14. The aerosol generating system of claim 12, wherein the receptor is disposed between the cavity and the second electrically resistive heating structure.

15. The aerosol generating system of claim 11, wherein, when the aerosol generating article is inserted into the cavity, the first electrically resistive heating structure is configured to contact the aerosol generating article.
